(19) United States
(12) Patent Application Publication
(10) Pub. No.: US 2014/0294257 A1
(43) Pub. Date: Oct. 2, 2014

(54) Methods and Systems for Obtaining Information Based on Facial Identification

(71) Applicant: Kevin Alan Tussy, Henderson, NV (US)

(72) Inventor: Kevin Alan Tussy, Henderson, NV (US)

(21) Appl. No.: 14/229,766

(22) Filed: Mar. 28, 2014

Related U.S. Application Data
(60) Provisional application No. 61/806,281, filed on Mar. 28, 2013.
(60) Provisional application No. 61/812,857, filed on Apr. 17, 2013.
(60) Provisional application No. 61/873,305, filed on Sep. 3, 2013.

(51) Int. Cl. G06F 17/30; G06K 9/00

(52) U.S. Cl. CPC G06F 17/30247; G06K 9/00295
USPC 382/118

(57) ABSTRACT

The methods and systems disclosed enable the association of data with individuals, organizations, places, objects, things with information, or a rating or score. Computer vision is used to identify the subject or capture an image of the subject's face. A portable computing device, such as a wearable computer, may include the cameras, microphones, to capture the image and communicate with a remote server or data sources. Facial data is sent to the remote server processing facial recognition processing to match the facial data with an identity. Upon determining a match, information about the matching identity is transmitted to the user of the portable computing device. The information about the subject may be the identity, or business or social information, or interests and hobbies. A score may be assigned to the subject that rates one or more aspects of the subject.

### 1. PRIORITY CLAIM

This application is related to, claims the benefit of and priority to U.S. Provisional Patent Application 61/806,281 filed Mar. 28, 2013, U.S. Provisional Patent Application 61/812,857 filed Apr. 17, 2013, and U.S. Provisional Patent Application 61/873,305 filed Sep. 3, 2013 which are all hereby incorporated by reference in their entirety.

### 2. FIELD OF THE INVENTION

The invention relates to information systems which provide data over a computer network and in particular to a real time method and apparatus for determining an individual's identity using facial characteristics to obtain information regarding the person.

### 3. RELATED ART

In many instances it may desirable for an individual to know more about a new person that they meet, such as if a individual is alone with that new person, or may interact with that person, such as through business, dating, or other relationship. There are many traditional methods to learn about a new person. Some of these prior art methods are to ask about the person's background or history, or to received documentation such as paperwork, sales proposals, or business cards from the person. However, these options force the individual to rely on the information provided by the person and this information, either oral or written, could be false. The individual would have little way of determining if the information was accurate or false.

Another option is to research the newly met person on a web site or to perform background checks. While this may provide a solution some of the time, there are many instances when the person can assume a new name or identity. This can be done by changing their name or by presenting a false name and history to the individual. As a result, even the best search would not yield accurate results.

In other instances, the individual needing the information may need to know right away whether the person they just met is being honest or has the background that is being asserted. Prior art methods suffer from being unable to rapidly determine the accurate information about the individual. For example, the person seeking the information would have to submit the information to a private investigator, or stop their interaction with the individual and search one or more databases. This interferes with the interaction, and even when the data is received, it may not be accurate.

Therefore a need exists for an improved method and apparatus to determine the identifying and background information regarding a person. A need is also present for people to selectively present information regarding themselves, interests, business, and personal data.

### SUMMARY

The methods and systems described herein enable the association of data with individuals, organizations, places, objects, etc. In the exemplary embodiment, computer vision is used to identify the subject. A portable computing device, such as a wearable computer, may include the cameras, microphones, and other input devices required to identify the subject and communicate with remote data sources. The data associated with the subject may be stored or determined using the portable computing device and/or remote servers. In some scenarios, data about the subject is retrieved and displayed using the portable computing device. In other scenarios, data about the subject is used to determine additional information about the subject.

In the exemplary embodiment, people may be identified using the portable computing device. More specifically, the face of the subject person may be identified using facial features compared with a database of known faces. Once identified, data about the person may be identified from a variety of data sources, including, but not limited to, social media and public records. The data about the person may be used to determine an overall score of the person which represents the nature of the data, whether positive or negative, but can be used to measure a person's score as a citizen—or a Citizen Score. Such a score may be used in making decisions about a person in a variety of circumstances. Because the score is made available at the portable computing device, a user can effectively get a review on a person in real-time and in person.

The same portable computing device that retrieves data and scores about a subject may also be used to provide feedback or reviews on that subject, for use in subsequent interactions, either with the same user or others. That is, upon identifying a subject, the user may provide feedback to the portable computing device which is transmitted to remote systems for storage. The feedback may be positive or negative, whether based in fact or opinion. Such feedback may be used to alter the score associated with a subject. Thus, users of the methods and systems described herein cooperate in a network of real world reviews and feedback and can access information about subjects as the subjects are encountered.

More broadly, the methods and systems described herein enable the association of information with real world subjects as well as the retrieval and analysis of such information. Subjects may provide information with which to be associated, enabling those who interact with the subject to receive such information. For example, subjects may provide advertisements, contact information, or messages, among other things. As described herein, provisions are made to avoid fraudulent reports in order to keep the subject data accurate and useful.

These and other details, concepts, aspects, embodiments, uses, and alternatives are described herein among the detailed description and accompanying figures. The subject matter disclosed herein is not limited to this brief description, which is provided as an overview to guide the reader. Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an example environment of operation.

FIG. 2 is a block diagram of an example embodiment of a mobile device or.

FIG. 2 is a block diagram of an example embodiment of a mobile device.

FIG. 4 is a block diagram of an exemplary server system and mobile device.

FIG. 5 illustrates an example view of a user using a mobile device, such as Google Glass®, to view a scene in a market and access ratings on unknown individuals.

FIG. 6 illustrates a scan of an unknown user 108 who may be linked to fraud or criminal activity.

FIG. 7 illustrates an example view of an unknown person and a possible criminal history.

FIG. 8 illustrates an example view of an unknown person who may be willing to share personal data in an effort to meet new people or connect with friends.

FIG. 9 is an example view of an unknown person promoting their business that was identified.

FIG. 10 illustrates an example view of a person using the identification system to offer an item for sale, in this example of motorcycle.

FIG. 11 illustrates an example view of a person using the identification system to link business services to his account.

### DETAILED DESCRIPTION

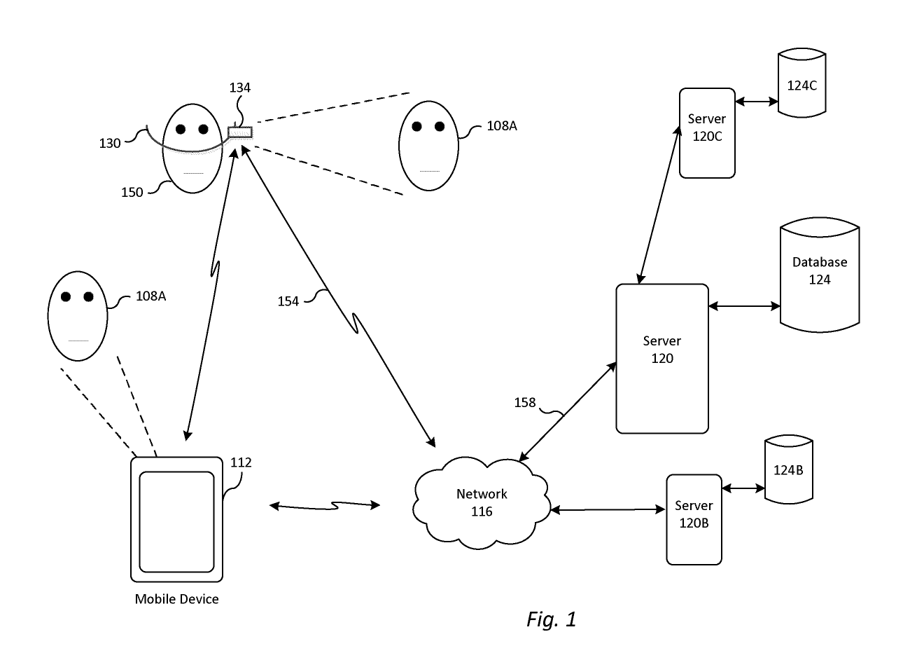

FIG. 1 illustrates an example environment of use of the unknown person identification system described herein. This is but one possible environment of use and system. It is contemplated that, after reading the specification provided below in connection with the figures, one of ordinary skill in the art may arrive at different environments of use and configurations. In this environment, a user 150 of the system is the person or entity that would like to obtain information about an unknown or partially known third party or unknown person 108. The user may have a mobile device 112 that is provided and capable of capturing a picture of the unknown person 108, such as an image of the person's face 108. The user may use the mobile device 112 to capture the image of the person 108. The mobile device may comprise any type mobile device capable of capturing an image, either still or video, and performing processing of the image or communication over a network. The mobile device 112 is described below in greater detail.

It is contemplated that the user 150 may carry and hold the mobile device 112 to capture the image. It is also contemplated that the user 150 may wear or hold any number of other devices. For example, the user may wear glasses 130 containing a camera 134. The camera 134 may point at the unknown person 108 to capture an image of the person's face 108. It is contemplated that the camera 134 may be part of a module that may either includes communication capability that communicates with either mobile device 112, such as blue tooth or other format, or communication directly with a network 154 over a wireless link. The glasses 130 or frame include a screen (not shown in FIG. 1) that resides in front of the user eyes to allow the user to view information displayed on the screen or superimposed on to the lens of the glasses 130. If the camera module 134 communicates with the mobile device 112 the mobile device may relay communications to the network 116.

The mobile device 112 is configured to wirelessly communicate over a network 116 with a remote server 120. The server 120 may communicate with one or more databases 124. The network may be any type network capable of communicating date to and from the mobile device. The server 120 may include any type of computing device capable of communicating with the mobile device 112. The server 120 and mobile device are configured with a process or memory and configured to execute machine readable code or machine instructions stored in the memory.

The database may contain images of people 108 that identify the person and associated data about the person 108 with the image. The data may be any type data selected by the person, by the system, or by a third party rating entity. Thus, depending on various factors, different levels of information may be associated with the person 108. Based on these factors, different information may be retrieved about the person. These factors may include who the requesting user 150 is, or their position, time of day, location, user 150 settings, person 108 settings, legal rules, or any other factor.

In this embodiment, the server 120 processes request for identification from the mobile device or user 150. In one configuration, the image captured by the mobile device, using facial detection, comprises an image of the unknown person's face 108. This image, represented as digital data, is sent over the network 116 to the server 120. Using image processing and image recognition algorithms, the server processes the persons face data and searches the database 124 for image data which represents a match. By using facial recognition processing, an accurate identify match may be established. Facial recognition processing is known in the art and as a result, it is not described in detail herein.

Also shown are a second server 120B with associated second database 124B, and third server 120C with associated third database 124. The second and third database may be provided to contain additional information that is not available on the server 120 and database 124. For example, one of the additional servers may be used and only accessed by law enforcement and store criminal records. Or, the criminal data may be accessible to anyone, but require a fee, or be separate for security concern.

One of the other servers and databases may be for users to update their personal information. For example, it is contemplated that a user or the system may keep records which include information about the person. Thus, data about the person is associated with the facial data that identifies that person. The facial data that identifies the person may be establish in anyway, such as by voluntary submission by the user 150 or person 108, by law enforcement, by social media such as Facebook® or Linkedin®, government or company data bases, or from any source other source.

### Facial Detection and Facial Recognition

Executing on the mobile device 112 is one or more software applications. This software is defined herein as an identification application (ID App). The ID App may be configured with either or both of facial detection and facial recognition. Facial detection is an algorithm which detects a face in an image. In contrast, facial recognition is an algorithm which is capable of analyzing a face and the facial features and converting them to biometric data. The biometric data can be compared to that derived from one or more different images for similarities or dis-similarities. If a high percentage of similarity is found between images additional information may be returned such as a name.

With the ultimate goal of matching a face of a person to an identity or image stored in a database, such as the person's name, the ID App may first processes the image captured by the camera to identify and locate the faces that are in the image. As shown in FIG. 1, there may be the face 108.

The portion of the photo that contains detected faces may then be cropped, cut and stored for processing by one or more facial recognition algorithms. By first detecting the face in the image and cropping only that portion of the face or faces, the facial recognition algorithm need not process the entire image. Further, in embodiments where the processing occurs remotely from the mobile device, such as at a server 120, much less image data must be sent over the network to the remote location.

In one embodiment the largest face as presented on the screen is captured and processed. In one embodiment faces that are smaller are next captured and processed. The processing may occur on the mobile device or at a remote server which has access to large databases of image data or facial identification data.

Facial detection software is capable to detecting a face from a variety of angles however facial recognition algorithms are most accurate in straight on photos in well lit situations. In one embodiment, the highest quality face photo for facial recognition presented on the screen is captured and processed first, then photos of faces that are lower quality or at different angles other than straight toward the face are next captured and processed. The processing may occur on the mobile device or at a remote server which has access to large databases of image data or facial identification data.

The facial detection is preferred to occur on the mobile device and performed by the mobile device software, such as the ID App. This reduces the amount of image processing that would occur and is beneficial for the facial recognition algorithms. Likewise, if transmitting to a remote server processing, bandwidth requirements are reduced.

It is contemplated that the facial recognition processing may occur on the mobile device or the remote server, but is best suited for a remote server since it will have access to faster and multiple processors and access to the large databases required for identification of the unknown person 108.

In some embodiments, if the database of known matches is sufficiently limited, the database may be stored on the mobile device and the facial recognition may be performed on the mobile device. For example, a large number of people suffer from memory issues, facial recognition deficiencies, or Alzheimer's disease. These people may have a database of ‘trusted and known’ faces (people) which may be less than 20, or less than 100 or less than 200 people. Given this limited volume of people and associated data, the person having memory issues can scan the face of the person, either with camera equipped glasses or the mobile device camera to determine if the person with whom they are interacting is ‘trusted and known’ and provide a name for that person. This will help avoid confusion, increase safety, reduce fraud, and improve the quality of life for those people and those around them. Likewise, in a company or at a seminar, the number of employees or attendees is limited.

### Identify Unknown Person

In one configuration when attempting to identify an unknown person the first step may be to determine or limit the set of people from which a selection is made. By identifying one or more aspects of the environment, a subset of potential unknown people maybe determined and identification accuracy increased. Thus, at a first step, the ID App captures a detects and captures the face. The portions of the faces may be cropped and either processed locally or in one embodiment sent over the network to a server which is configured to access a database of images. Only the cropped portion may be sent to the remote database to reduce bandwidth requirements and speed processing. Additional data may be sent to limit the possible matches by establishing a subset. The factors that establish the subset may include location, time of day, environment, or any other factor. By limiting the subset of possible unknown people the identity of the person can be predicted with higher certainty. This may be referred to as compounding probability where one or more detectable or knowable aspects of the unknown person, location, time, date, type of event or other factor are added to the processing algorithm to improve accuracy. For example, if two possible matches are located for a person detected and imaged in Colorado, the possible match that is located, based on earlier face book post or positive detection one hour ago in New York, can be eliminated, thereby establishing the other possible match as the correct match.

At the remote server, the server software performs facial recognition on the one or more faces that are captured by the ID App. During the person identification process the application may continually send images, in the form of cropped faces from the unknown person. The more facial image data provided for processing, the more accurate the facial recognition.

The image processing software on the remote server compares the image of the face of the unknown person to images in a database of known people to determine match. An list of possible matches may be made. The list of possible matches from these faces may also establish a list of names for each face.

Upon identifying the unknown person with a likely match, the remote server transmits the match data to the mobile device for display to the user. The data may be displayed on the mobile device screen or on glasses worn by the user. In one embodiment the data is converted to an audio signal and presented to the user as a audio signal. The user may then use this data to identify make a decision regarding how to interact with this person or what to say to this person.

### Additional Matching Routines

In one embodiment, audio of a microphone captures for name or voice profile for the unknown user using voice recognition software routines. If a name of the unknown person is identified, the name of that potential matches is compared to the names detected by the microphone to determine a likely match for the unknown actor.

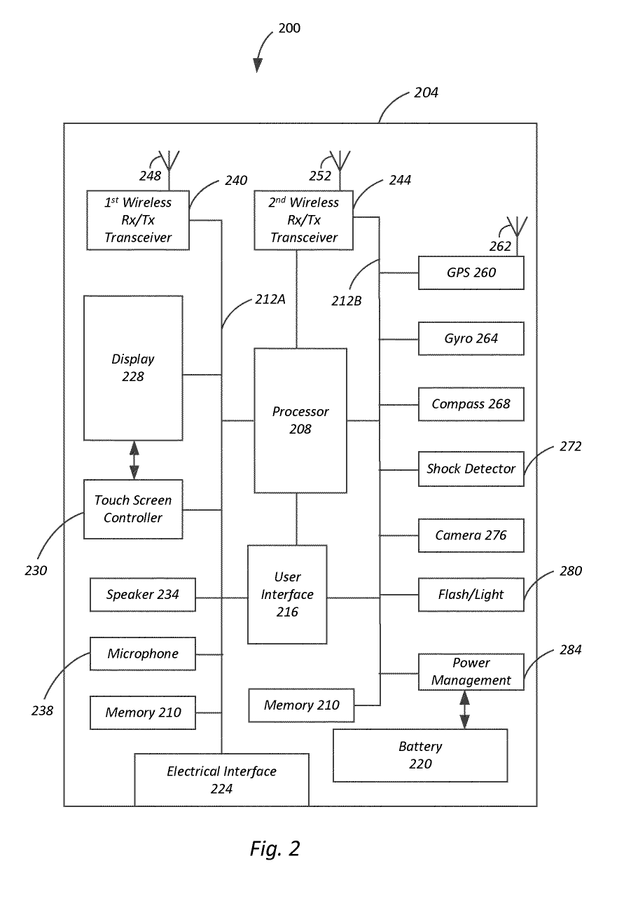

FIG. 2 illustrates an example embodiment of a mobile device. This is but one possible mobile device configuration and as such it is contemplated that one of ordinary skill in the art may differently configure the mobile device. The mobile device 200 may comprise any type of mobile communication device capable of performing as described below. The mobile device may comprise a PDA, cellular telephone, smart phone, tablet PC, wireless electronic pad, or any other computing device.

In this example embodiment, the mobile device 200 is configured with an outer housing 204 configured to protect and contain the components described below. Within the housing 204 is a processor 208 and a first and second bus 212A, 212B (collectively 212). The processor 208 communicates over the buses 212 with the other components of the mobile device 200. The processor 208 may comprise any type processor or controller capable of performing as described herein. The processor 208 may comprise a general purpose processor, ASIC, ARM, DSP, controller, or any other type processing device. The processor 208 and other elements of the mobile device 200 receive power from a battery 220 or other power source. An electrical interface 224 provides one or more electrical ports to electrically interface with the mobile device, such as with a second electronic device, computer, a medical device, or a power supply/charging device. The interface 224 may comprise any type electrical interface or connector format.

One or more memories 210 are part of the mobile device 200 for storage of machine readable code for execution on the processor 208 and for storage of data, such as image data, audio data, user data, medical data, location data, shock data, or any other type of data. The memory may comprise RAM, ROM, flash memory, optical memory, or micro-drive memory. The machine readable code as described herein is non-transitory.

As part of this embodiment, the processor 208 connects to a user interface 216. The user interface 216 may comprise any system or device configured to accept user input to control the mobile device. The user interface 216 may comprise one or more of the following: keyboard, roller ball, buttons, wheels, pointer key, touch pad, and touch screen. A touch screen controller 230 is also provided which interfaces through the bus 212 and connects to a display 228.

The display comprises any type display screen configured to display visual information to the user. The screen may comprise a LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 228 receives signals from the processor 208 and these signals are translated by the display into text and images as is understood in the art. The display 228 may further comprise a display processor (not shown) or controller that interfaces with the processor 208. The touch screen controller 230 may comprise a module configured to receive signals from a touch screen which is overlaid on the display 228.

Also part of this exemplary mobile device is a speaker 234 and microphone 238. The speaker 234 and microphone 238 may be controlled by the processor 208 and thus capable of receiving and converting audio signals to electrical signals, in the case of the microphone, based on processor control. Likewise, processor 208 may activate the speaker 234 to generate audio signals. These devices operate as is understood in the art and as such are not described in detail herein.

Also connected to one or more of the buses 212 is a first wireless transceiver 240 and a second wireless transceiver 244, each of which connect to respective antenna 248, 252. The first and second transceiver 240, 244 are configured to receive incoming signals from a remote transmitter and perform analog front end processing on the signals to generate analog baseband signals. The incoming signal maybe further processed by conversion to a digital format, such as by an analog to digital converter, for subsequent processing by the processor 208. Likewise, the first and second transceiver 240, 244 are configured to receive outgoing signals from the processor 208, or another component of the mobile device 208, and up convert these signal from baseband to RF frequency for transmission over the respective antenna 248, 252. Although shown with a first wireless transceiver 240 and a second wireless transceiver 244, it is contemplated that the mobile device 200 may have only one such system or two or more transceivers. For example, some devices are tri-band or quad-band capable, or have Bluetooth communication capability.

It is contemplated that the mobile device, and hence the first wireless transceiver 240 and a second wireless transceiver 244 may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device is one or more systems connected to the second bus 212B which also interface with the processor 208. These devices include a global positioning system (GPS) module 260 with associated antenna 262. The GPS module 260 is capable of receiving and processing signals from satellites or other transponders to generate location data regarding the location, direction of travel, and speed of the GPS module 260. GPS is generally understood in the art and hence not described in detail herein. A gyro 264 connects to the bus 212B to generate and provide orientation data regarding the orientation of the mobile device 204. A compass 268 is provided to provide directional information to the mobile device 204. A shock detector 272 connects to the bus 212B to provide information or data regarding shocks or forces experienced by the mobile device. In one configuration, the shock detector 272 generates and provides data to the processor 208 when the mobile device experiences a shock or force greater than a predetermined threshold. This may indicate a fall or accident.

One or more cameras (still, video, or both) 276 are provided to capture image data for storage in the memory 210 and/or for possible transmission over a wireless or wired link or for viewing at a later time. The processor 208 may process image data to perform image recognition, such as in the case of, facial detection, item detection, facial recognition, item recognition, or bar/box code reading.

A flasher and/or flashlight 280 are provided and are processor controllable. The flasher or flashlight 280 may serve as a strobe or traditional flashlight. A power management module 284 interfaces with or monitors the battery 220 to manage power consumption, control battery charging, and provide supply voltages to the various devices which may require different power requirements.

FIG. 3 illustrates exemplary software modules that are part of the mobile device and server. Other software modules may be provided to provide the functionality described below. It is provided that for the functionality described herein there is matching software (non-transitory machine readable code, machine executable instructions or code) configured to execute the functionality. The software would be stored on a memory and executable by a processor.

In this example confirmation, the mobile device 304 includes a receive module 320 and a transmit module 322. These software modules are configured to receive and transmit data to remote device, such as cameras, glasses, servers, cellular towers, or WIFI system, such as router or access points.

Also part of the mobile device 304 is a location detection module 324 configured to determine the location of the mobile device, such as with triangulation or GPS. An account setting module 326 is provided to establish, store, and allow a user to adjust account settings. A log in module is also provided to allow a user to log in, such as with password protection, to the users account. A facial expression module 308 is provided to execute facial detection algorithms while a facial capture module includes software code that captures the face or facial features of an unknown person.

An information display module 314 controls the display of information to the user of the mobile device. The display may occur on the screen of the mobile device, or projection or display on glasses, contact lens, or audio signal. A user input/output module 316 is configured to accept data from and display data to the user. A local interface is configured to interface with other local devices, such as using Bluetooth of other shorter range communication, or wired links using connectors to connected cameras, batteries, data storage elements. All of the software (with associated hardware) shown in the mobile device 304 operate to provide the functionality described herein.

Also shown in FIG. 3 is the server software module 350. These modules are located remote from the mobile device, but can be located any server or remote processing element. As is understood in the art, networks and network data uses a distributed processing approach with multiple servers and database operating together to provide a unified serve. As a result, it is contemplated that the module shown in the server block 350 may not all be located at the save server or same physical location.

As shown in FIG. 3, the server 350 includes a receive module 320 and a transmit module 322. These software modules are configured to receive and transmit data to remote device, such as cameras, glasses, servers, cellular towers, or WIFI system, such as router or access points.

An information display module control display of information at the server. A user input/output module controls a user interface in connection with the local interface module 360. Also located on the server side of the system is a facial recognition module 366 that is configured to process the image data from the mobile device. The facial recognition module 366 may process the image data to generate facial data and perform a compare function in relation to other facial data to determine a facial match as part of an identify determination.

A database interface 368 enables communication with one or more databases that contain information used by the server modules. A location detection module 370 may utilized the location data from the mobile device for processing and to increase accuracy. Likewise an account setting control user accounts and may interface with the account settings module 326 of the mobile device. A secondary server interface 374 is provided to interface and communicate with one or more other servers.

One or more databases or database interfaces are provided to facilitate communication with and searching of databases. In this example embodiment the system includes an image database that contains images or image data for one or more people. This database interface 362 may be used to access image data of third parties as part of the identity match process. Also part of this embodiment is a personal data database interface 376 and privacy settings data module 364. These two modules 376, 364 operate to establish privacy setting for individuals and to access a database that may contain privacy settings. A criminal or fraud modules 378 may be provided to process situations when the system determines that the identified person is or may be a criminal or committing fraud. Likewise, if a crime is being committed, the module may be activated. Upon activation, a priority notice may be provided to the user and law enforcement may optionally be called to investigate and protect the user who captured the image of the criminal.

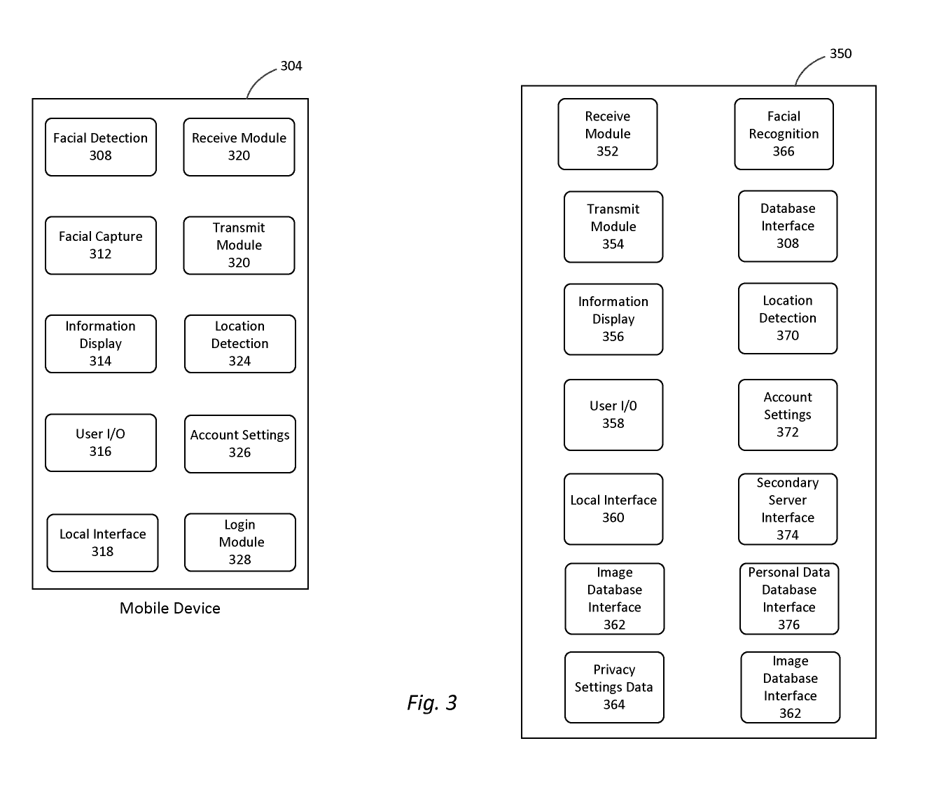

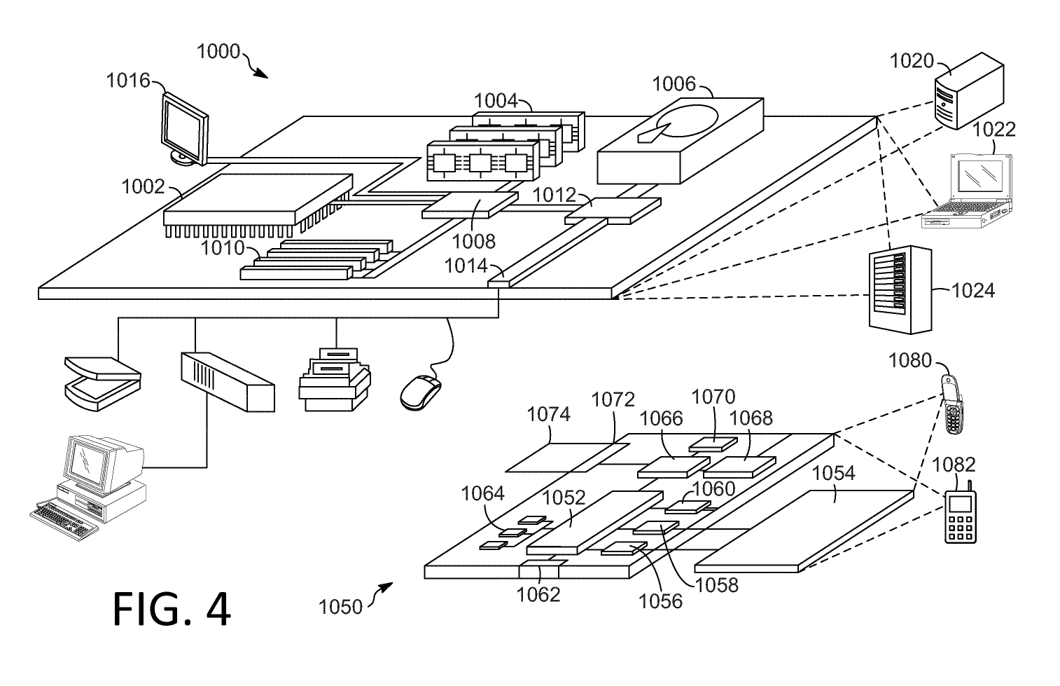

FIG. 4 is a block diagram showing example or representative computing devices and associated elements that may be used to implement the functionality described herein. FIG. 4 shows an example of a generic computing device 1000 and a generic mobile computing device 1050, which may be used with the techniques described here. Computing device 1000 is intended to represent various forms of digital computers, such as server laptops, desktops, workstations, servers, blade databases, mainframes, and other appropriate computers. Computing device 1050 is intended to represent various forms of mobile devices, such as personal digital assistants, tablets, camera equipped glasses, user wearable cameras or computing devices, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device. The computing device 1050, which may be referred to as a mobile device, is also equipped with one or more cameras.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer or a mobile device having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include mobile devices and servers. A mobile device and server are generally remote from each other and typically interact through a communication network. The relationship of mobile device and server arises by virtue of computer programs running on the respective computers and having a mobile device-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

This invention may utilize a camera and a digital display device, and in most cases they may be combined into one device but the display device and the camera device may be separate. For example a digital display integrated into contact lenses may be used as the display device and the camera could be a wearable device such as a pen, hat or button.

As disclosed in the accompanying FIGS. 1 through 7 and herein, in various exemplary embodiments, a wearable camera device running face-recognition or other identification software and networked to a database may be used by a wearer to visually scan an area such as the area the wearer is looking at with their natural eyes. If a face of another person is recognized by the camera and identification software, a photo/video may be taken and sent to the server or facial data points may be determined and be sent to a database to be matched against information about individuals to identify the subject. In the alternative, other identifying data could be gathered by the camera device or other devices on the user, and sent to a database to identify subjects in the selected area. If a match is found, then information from the database may be provided to the wearer, including things like name, age, country, city of birth, marital status, hobbies, favorite sports teams, universities, educational degrees, as well as information posted by peers about the character of the person. This information may be downloaded to the wearer's device or another device to be displayed in real time or in the future.

Much of the information about an identified individual can be obtained through public means, and scanning social networking sites such as Facebook and Google+. Online photos associated with a person's account may help to create additional records of facial recognition data points. Criminal information and mug shots may also be used to load important information about potentially dangerous individuals and may be used in conjunction with the database information and facial recognition. Some or all of the available information about the person can be used to rate their character. For example, in one exemplary embodiment, a rating of human character may be created using an algorithm that considers many different data points combined and considered over time to identify a score on a scale, such as 1-100. A score of 100 would be a perfect citizen, with strong character ratings in every data area. This rating of character may be called a Citizen Score or CitScore or some other moniker.

Such a character score may reflect inputs from a wide range of data points including direct feedback from people who have encountered the person. For example, if someone lies to you, you could take a picture of his face, and tell the system to post a review to his character score. Now other people who see this person will also be able to see that he has recently had a complaint and his character score will be lower as a result.

Since the system may be able to identify the subject via facial recognition or other means, the reviewer may not need to know the name of the person they wish to review. They may only have an image of the other person's face. In some cases of recording video they, may rewind to find a certain frame where facial data points can be retrieved. The system may be constantly using the camera to scan for faces and faces may be automatically checked against the database. If a face is recognized by the system, the wearer may be alerted. For example, the wearer may be alerted to the presence of a friend, competitor, colleague, criminal, registered sex offender, wanted criminal, subject of an AMBER alert, etc.

If they are not found or the database is not able to make a positive identification then the photo may be logged and the wearer can come back and review the unknown individual at a later time. A logged GPS location of where an individual was last “seen” could be used by law enforcement to locate criminals or lost children. This could be integrated to work with a range or products so that for example, the user could just take a picture with Google Glass and say “review person” then say “they stole my bike” or “dangerous driver” etc. Reviews may or may not be posted anonymously if the reviewer possesses a high enough character score.

A driver's license plate or other unique identifying information can also be used to record data and reference it. For example a driver may cut off another driver wearing Google Glass while running the application. First the wearer may make a vocal command such as “CitScore Picture” and a photo of the license plate on the other car would be taken. Then if the wearer was able to pull up next to the driver at the next red light and see the drivers face the wearer could take another photo and combine them in the database. Then the wearer may make a comment as to the reason that they were recording the photos—in this case, “reckless driver.”

If a user is wearing a thought scanning device or similar feeling sensing device that provides for direct measurement of their reactions and emotions, that information could be added to the reviews of individuals that they interact with. Their thoughts about a person's character upon seeing that person could be uploaded to the database and contribute to the person's character score.

In various exemplary embodiments, the result is a character score that anyone can access just by scanning a photo of another person's face. By creating a means for feedback and a means for others to view that feedback, individuals will ultimately choose to be on their best behavior and be nice to others because any negative actions have consequences that would be detrimental to their CitScore. The result should be a reduced prevalence of stereotypes and racial profiling, as the character scores should encourage people to treat each other fairly based on objectively relevant score rather than appearance, outward observations or first impressions.

Various algorithms may be used to determine the score or ratings. Ratings from people with high scores may hold more weight, over time negatives may get weighted less, if a person has a low score they may not be able to rate people at all. Someone who gives a lot of negative feedback and no positive feedback may have their opinions weighted less as compared to someone that gives mostly positive and then a negative. A 2nd tier of feedback from others could disqualify a score that is obviously just spiteful, and if someone wants to put up something deeply negative they may have to confirm it a few times over a few months.

Revenue may be obtained by the operator of the system, including the camera, digital display, backend systems, software applications, and database(s) in a variety of ways. Users may be willing to pay for access or for different levels of information. Employers may wish to see the in-depth comments to screen prospective employees. Retailers may wish to give those with high character scores discounts and be willing to pay to advertize to those people. Law enforcement may pay rewards for assistance in locating wanted criminals. Individuals may want to pay to access the full record of someone that they are interested in dating. Individuals who have received poor reviews may also be willing to pay to have a 3^{rd} party evaluate the review and potentially invalidate it, etc.

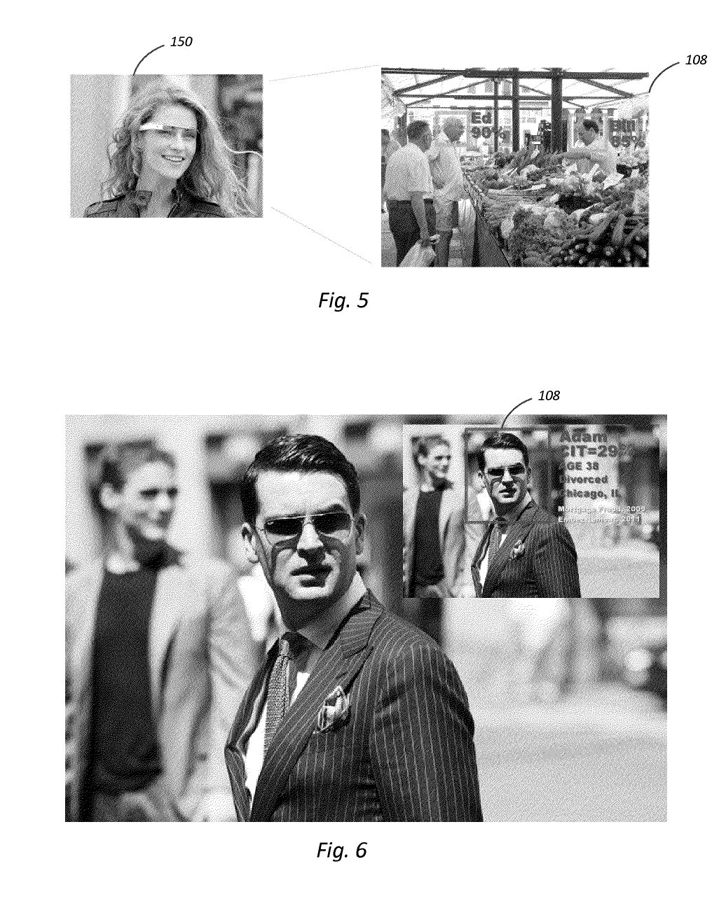

FIG. 5 illustrates an example view of a user 150 using Google Glass® to view a scene in a market and access ratings on individuals 108 in the field of view. FIG. 6 illustrates a scan of an unknown user 108 who may be linked to fraud or criminal activity.

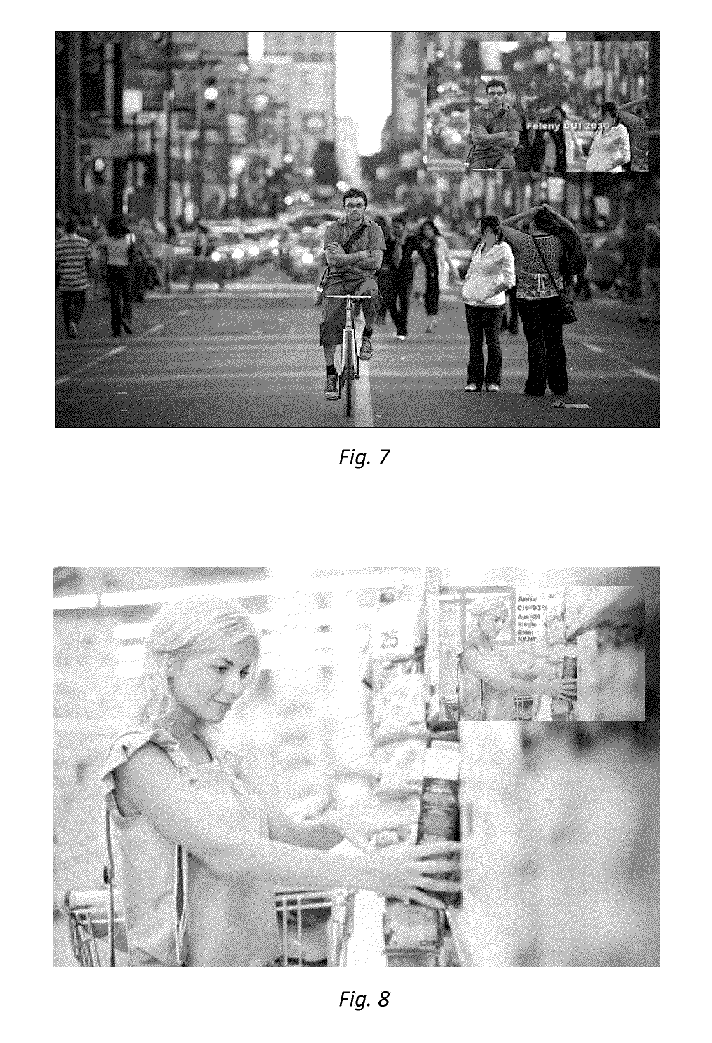

FIG. 7 illustrates an example view of an unknown person and a possible criminal history. This may be relevant if the person is offering a ride, or apply for a job as a delivery driver. FIG. 8 illustrates an example view of an unknown person who may be willing to share personal data in an effort to meet new people or connect with friends

The concept of a character score can also be applied to entities such as companies or associations. In various exemplary embodiments, a company logo could be recognized though the camera by the facial/detail software or through any other appropriate sensing device (RFID, etc.) and the GPS coordinates of where that image was registered could be stored and used to track what location a person is visiting. Character scoring and other reviews can be entered for specific employees at a particular location, for the particular location, and/or for the company in general.

In various embodiments, systems can be developed to prevent fraud or manipulation of character scores. For example, it may become evident to some that trying to achieve a high character score through fraudulent means could be beneficial to them. A variety of strategies can be used to ensure that reviews are honest and are not solicited by individuals who are attempting to achieve a high score though manipulation. In various exemplary embodiments, analytics such as the length of interaction can be recorded and compared to the description of the interaction by the reviewer for consistency. Location information can also be used to ensure that reviews are consistent with the location of the reviewer and reviewed. For example, fraud could be flagged based on use of a still image to review a person which could be determined by the system through the lack of movement, or the location of the reviewer and the reviewed never being in close proximity. Attempts to submit fraudulent reviews could also cause the reviewer's character score to be lowered and their past and future reviews to be nullified and/or given less weight.

In some situations a person may be required to perform a job that results in the general public becoming upset at them. In various exemplary embodiments, the system provides for different scoring to reflect business or “on duty” actions and other actions. This may be a police officer or representative of another government agency such as a building inspector. In various exemplary embodiments, since individuals cannot change their faces while working they can submit that they are “on duty” during certain hours. The system may also require that the employer confirm that they are on duty. Any ratings that were done based on interactions during the “on duty” hours might not be considered for that individual's character score but could be segmented for employers or people that interact with the “on duty” officer to view separately. This would benefit the individual because their non-work related character score would remain higher and the employer can see what their character score is during work related interactions. If desired, the organization could request that a character score is not displayed and only shows “On Duty Police Officer” to anyone who interacts with them while using the character score application.

In various exemplary embodiments, the system may weigh different interactions differently. For example, an interaction without a review may be considered a slightly positive review. If a person sees another person's character score and interacts with them and then does not choose to review them either positively or negatively it can be assumed that the interaction was pleasant and that the person thought the other person's character score rating was accurate. If it was too low they would be more likely to review the person higher, or if too high they would be more likely to voice the negative option.

In various exemplary embodiments, the character score can also be used in connection with a marketplace. When choosing someone to do business with an individual often relies on reputation and sites like Angie's List and Yelp have made reviewing business possible online but not in person. By utilizing a device such as Google Glass and the Citizen Score Software a user can see a character score of the potential business associate and can make choices accordingly in real time and in person.

In various exemplary embodiments, in order to take advantage of this potential marketing opportunity an individual with a high character score may want to display their business name, occupation, items for sale or other services for hire when others view them. This advertising feature will promote local commerce and allow those with high scores to trade on their reputations even with total strangers. This feature could be turned on and off by the individual so that they could display this information at a convention but not at the supermarket.

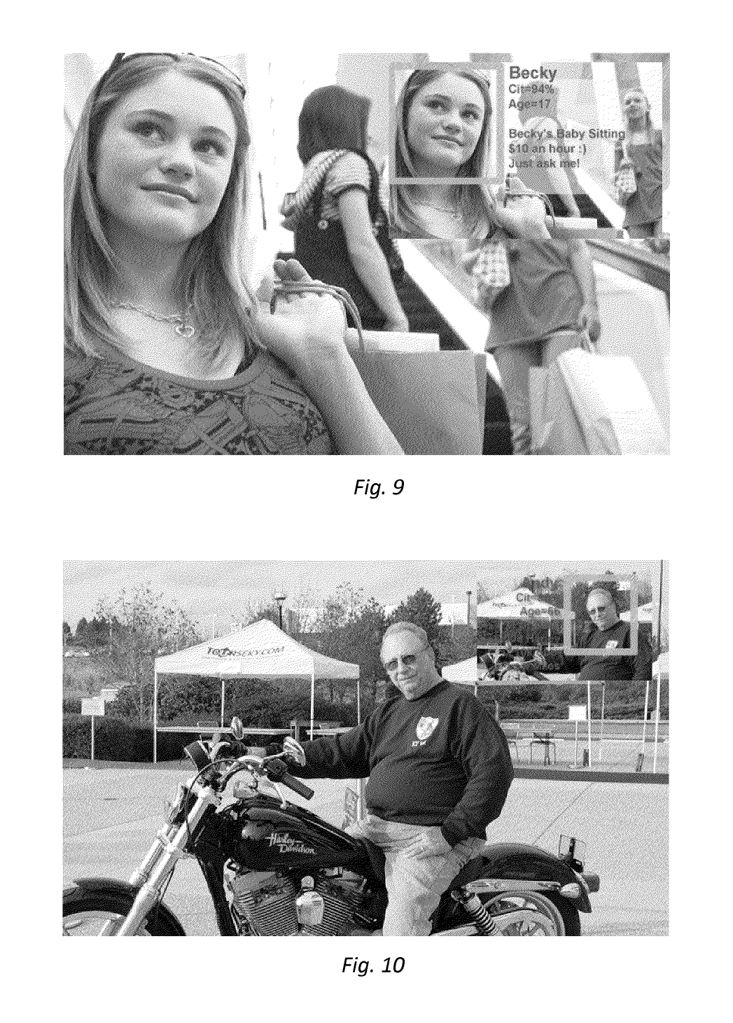

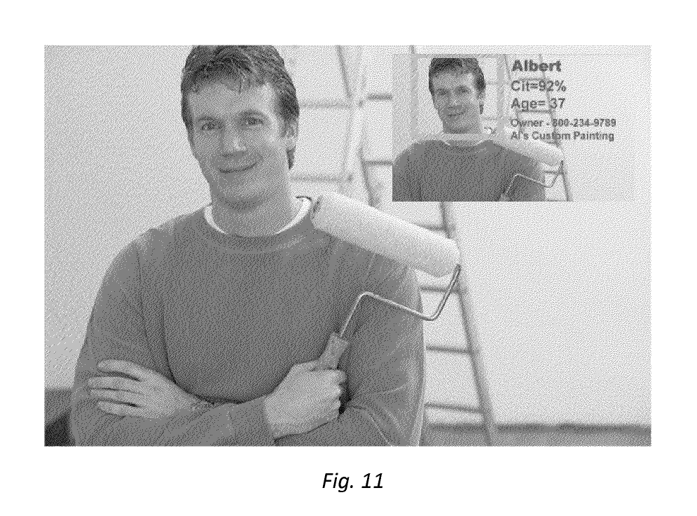

FIG. 9 is an example view of an unknown person that was identified. This person in FIG. 9 elected to display business information to users in effort to obtain child care services. FIG. 10 illustrates an example view of a person using the identification system to offer an item for sale, in this example of motorcycle. FIG. 11 illustrates an example view of a person using the identification system to link business services to his account. In many of these examples, limited personal information is provided, if any, but that any type information may be linked to the persons identify. The user has the choice to share any or no information and the type of information that is shared.

Various methods, systems, features, and embodiments are described herein, including the following. The systems and methods described herein may be implemented as software, including a web service or web site. One such implementation is known as Citizen Score, with scores sometimes referred to as CitScores.

Establishing that an Interaction Occurred Between Individuals

A registered user who has had their face scanned (and a photo and data points are stored in the database) can upload a photo containing their face and the face of another person that they wish to rate. This photo of the two or more people will be scanned and the faces determined if they are matches to the users face and/or another person in the database. The registered user can then rate the other person in the photo and enter their name and other information. Because both of the people appear in the photo we can assume that there was some level of interaction between them and that they know each other on some level. We can also use some kind of full name check or other personal information check to validate that they know each other.

### Use of Social Network Connections to Identify Interactions

Users of the Citizen Score software may potentially use online relationships to determine interactions. For example if two Citizen Score users are Facebook friends they may wish to rate each other on Citizen Score. Users of Citizen Score may also potentially allow friends/connections from social media sites to rate them by checking a box inside their own Citizen Score privacy settings.

### Adjustment of the Information Display Layout

When a user visualizes another individual while wearing an augmented reality system, the user can select from multiple display patterns of the information returned by the Citizen Score software and also allow the display of any additional information that the user has paid to access. This may result in a certain layout that features only a first name, or first and last name. It may also be conditional, where as a person with a high citizen score's score appears small but a person with a low citizen score or a criminal record their Citizen Score appears large or is colored in red or is flashing etc.

### Web Scans of Images

On CitizenScore.com a visitor can upload a photo, take a photo with a webcam or phone camera or provide the URL of a photo. The server will perform the scan of the photo and analyze the face. If a match is found, all or some of the information contained in the database about that person will be displayed. If no match is found another photo may be uploaded and the search tried again. An in-depth background check may also be offered as an additional service.

For Example: A woman using a dating website in interested in finding out if a man that she may potentially date has a good Citizen Score. She can download or copy the URL of a profile photo from a dating website or a social media site of the man and then paste or upload the information into CitizenScore.com. The photo will be scanned and the data points searched in the database for a match.

### Facial Recognition of Criminals Using Aliases

Many criminals in an effort to hide their past deeds from the public, employers or law enforcement utilize aliases. By scanning the internet and law enforcement websites, mug shots and registered photos of known criminals that their information may be loaded into the Citizen Score Database. A person can then take a photo found on an online dating or social media website or a photo taken with a device such as a smart phone or Google Glass and that photo will be compared against the faces in the database. If a match or a probable match is found the searcher will be shown information in the database about the criminal. Even if the criminal is using an alias they can be identified by their face and the searcher may not become a future victim of the criminal.

### Data Input Match to Access in Depth Personal Information

Since an individual is matched to their CitScore through facial recognition, to protect privacy we could make a user enter a person's name that they interacted with to see intimate details, for example, if you enter their first name, you can see last name, age martial status etc. but if you don't know their name or registered alias then you could only see their CitScore not any personal info.

Other techniques may be used to determine how much data to reveal about a person. For example, social media contacts, or specially identified people may be able to view additional details about a person.

### User Selected Privacy Settings

A person can create an account on CitizenScore.com and then may select their own privacy settings. For example they may choose to have their name displayed when others scan them, or a nickname, or no name at all. They may choose to have their age, alma matter, employer or marital status displayed, etc. CitScore isn't about identifying people by name but by reputation.

In one embodiment, the unknown person (subject) whose identify is being discovered may control the amount and type of information shared by their privacy profile by manually establishing the settings. It is also contemplated that the amount of information about an unknown person or subject be limited to the same level of information that the user is willing to share with others. For example, if the user sets their privacy settings to first name only being disclosed, then that user will only be able to receive the first name from people they submit to the server for identification.

It is also contemplated that the user or other subjects or unknown persons may set their privacy setting based on the time of day, location, or event. For example, when at work or at a work related conference, their privacy setting may automatically only allow work related information to be shared with other people. In this capacity, the person's face may function as a visual business card to share business or contact information. This may be downloaded, controllably by the user, to the user's contact list. However, when that person is in a social environment, the privacy settings will not share work information, but instead a social profile that may include hobbies or favorite cocktail, music or movie.

The system may also serve as a method of determining the identity of individuals who scanned the user, such as by reporting back to the user the identify or nature of people who scanned them. Or, the info about people who scanned the user may be provided. This feedback may be helpful in social or business situations to determine if the user is not in the proper business or social situation or obtain feedback regarding the person's presentation. In one embodiment, feedback may be provided to the user regarding one or more aspects of the persona. The type and nature of the feedback received would be controlled by the user.

In one configuration the facial detection system may be used by social workers to identify homeless people or people in need. Likewise, law enforcement may use the facial recognition system to identify information about a person. By accurately identifying a person, and dynamically an in real time obtaining information about the person, more accurate decisions may be made. Social benefits may be accurately dispensed thereby reducing fraud. Law enforcement may use information about a person to learn if they have a medical condition or mental issue or handicap that may prevent them from responding or cause them to act inappropriate. Police may react differently to a person with no arrest record and a medical condition, and a person facially detected to have a history of assaulting police. A person with a history of DUI arrests, revealed by the facial scans, may be treated differently than a person with a history of diabetic low blood sugar symptoms. A simple facial scan can provide the identity of a person even if that person eludes capture by the police.

### Voice Recognition to Aid Facial Identification

If a user of Citizen Score software on a smart phone or Google Glass has an interaction with another individual and the user Says “Hello Antonio” or the viewed individual says “My name is Antonio” the application can use voice recognition to process the name “Antonio” and to help assist with the facial recognition search. If the facial recognition software says that it has two probable matches, one named “James” and one named “Antonio,” the Citizen Score software would use the name “Antonio” as the deciding factor to display the CitScore for Antonio.

### Rating Questions Variability Based on Length and Type of Interaction

When a user selects the type, length and quality of an interaction those selections may result in changes to the rating questions that are available to the user. For example, if an interaction is short, fewer questions or different questions may be asked of the reviewer than if an interaction is lengthy and of a type that is more substantial.

### Different Questions for Opposite Gender Ratings

Some rating may not display for both sexes. For example, a woman may be asked for her level of comfort with a particular man. Her choices may be from Creepy to Very Comfortable.

### Different Ratings Displays for Opposite Gender CitScore Views

A woman may choose to see different rating criteria when she searches for and views the CitScore profile of a man and a man may wish to see different information displayed when he views the profile of a woman than he does when he views a man. Examples of this may be that a woman wishes to see the ratings from other women of their comfort level when around the man. This can help women feel more safe when choosing who to interact with and in what environments.

Display the Ratio of Positive to Negative Ratings that a Rater has Made

To ensure that raters don't only use CitScore to voice their negative opinions, a ratio of negative to positive comments will be displayed to users on their profile page. If a user becomes too negative in their reviews that will negatively impact the weight of all their reviews.

Display the Ways an Individual can Raise their Citscore

To help encourage users to strengthen their characters through good actions when a user is viewing their own CitScore profile, we may display the areas that that they would benefit most from higher rating. This is so the user can be aware of the areas that they should focus to strengthen their character and as a result increase their CitScore.

### 180 Degree Face Scan to Access Account

The system may scan video frames and save them for future scanning. The user may be asked to watch a digital object on their computer screen that moves from side to side, up and down or in any number of patterns. This random movement combined with head and or eye tracking and the facial recognition software will prove that the user is indeed in front of the webcam in real life and is the individual in the stored profile photo.

### Rebuttal System for Negative Comments

If comments are left on an individual's profile then we may allow the person who the comment was about one short rebuttal to give some perspective to the comment.

Show Citscore of the Commenter when Comments are Viewed

When an individual is looking at the comments left for themselves or of another individual on CitizenScore.com the CitScore range of the user that left the comment will be displayed. This will help to add perspective to what the comment says.

### CitScore Quick Rating

When you search for and then view a CitScore for someone, you can voice your opinion as to whether the CitScore is accurate. This may be a quick rating, just four choices, for example: I don't Know, This CitScore is Too Low, Too High, or Perfect.

### Method for Grouping Photos by Individual

Facial recognition software can be used to compare a photo to another in a database and return a % probability that there is a match.

In many cases the facial expression, angle, hat or glasses an individual is wearing in a photo can cause the facial recognition software to fail to discover a high probability for a match. It is often beneficial to the facial recognition software and the overall application it is being used for to have multiple photos of the same person to compare. However, if the facial recognition software fails to match the photos with a high % of probability they will not be considered the same person and they will remain separate accounts.

Humans may be utilized to help to identify photos that should be grouped and flag those that should not be. Other randomly selected humans may be used to validate and verify the photos that other humans have flagged.

If a server is scraping the internet for photos and then attempting to match them with other photos using facial recognition software the server will invariably create multiple accounts for the same individual.

When a new photo of an individual is scanned, both of the existing photos in the database may come up as separate results. The searcher may then recognize that the new photo and the 2 existing photos are the same individual.

The searcher may then make a selection that indicates that the 3 photos are of a single individual and should be grouped as 1 individual not as 2 individual or 3 individuals each with a corresponding account. Searcher selections can be used as guidelines but cannot be considered accurate as some people may make mistakes or have fraudulent intentions.

However, by using randomly selected secondary searchers and asking them to match the previously grouped photos together we can get a second opinion of the validity of the groupings in order to improve the quality of the groupings. Over time the photos will become grouped correctly by individual and new photos will be continually added to the individual accounts.

The more searchers and photos that are entered the more photos will be grouped correctly and the more inconsistencies will be flagged and by harnessing collective intelligence the overall database of photo accounts will be more accurate and facial recognition searches will return better results.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components (including, among other things, engines, layers, and applications), capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. One or more processors may be programmed or configured to execute any of the computer-executable instructions described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for storing or retrieving information about a subject a
receiving facial data transmitted from a user's mobile device, the facial data captured based on an image of a person, the image captured by the user;
performing facial recognition processing on the face data to establish facial recognition data;
comparing the facial recognition data to a database of facial recognition data to identify a match;
upon identification of match, recalling one or more privacy setting for the identified match;
responsive to the privacy setting, recalling one or more items of personal information regarding the identified match;
transmitting the personal information regarding the identified match to the user, for display to the user.

2. The method of claim 1, wherein the mobile device performs facial detection on the image.

3. The method of claim 1, wherein the information sent to the user is further limited to not exceed the personal information that would be shared by the user.

4. The method of claim 1, wherein the personal information comprises information regarding nature of products or services sold or offered by the identified match.

5. The method of claim 1, wherein the privacy setting controls which, if any, personal information that the comparison will send to the user.

6. A system for storing or retrieving information about a subject, the system comprising:
a mobile device comprising:
a camera configured to capture an image of an unknown person;
a mobile device processor and memory, the memory storing non-transitory machine executable instructions configured to process the image to create facial data;
a transceiver configure to transmit the facial data to a server and receive identity information from the server;
a display configured to display identify information;
the server comprising:
a transceiver configured to receive facial data and transmit identity information
a server processor and memory, the memory storing non-transitory machine executable instructions configured to:
process the facial data to obtain a corresponding identity;
analyze privacy setting for the identity;
responsive to the privacy settings, retrieve identify information for transmission to the user.

7. The system of claim 1, wherein the identity information does not include the full name of the unknown person.

8. The system of claim 1, wherein the identity information does not include the full name of the unknown person.

9. The system of claim 1, wherein the identity information does not include the full name of the unknown person.

10. The system of claim 1, wherein the privacy settings establish what identity information will be sent to the user.

11. The system of claim 1, wherein no more information regarding the identity of the unknown person will be sent to the user than the user is will willing to share with other users.
